(19) United States
(12) Patent Application Publication
(10) Pub. No.: US 2021/0073093 A1
(43) Pub. Date: Mar. 11, 2021

(54) Testing Method of Reporting Test Results of Multiple Client Computers to Server and Testing System Utilizing Same

(71) Applicants: Inventec (Pudong) Technology Corp., Shanghai (CN); Inventec Corporation, Taipei (TW)

(72) Inventors: Kun-Tsung Huang, Taipei (TW); Ming-Hung Chang, Taipei (TW)

(21) Appl. No.: 16/574,043

(22) Filed: Sep. 17, 2019

(30) Foreign Application Priority Data
Sep. 6, 2019 (CN) 201910844055.3

(51) Int. Cl. G06F 11/26; G06F 11/30; G06F 11/34; H04L 29/06

(52) U.S. Cl. CPC G06F 11/26; G06F 11/3006; H04L 67/42; G06F 11/3495; H04L 63/104; G06F 11/3065

(57) ABSTRACT

A testing method includes at least one client computer executing a system test; when a system error occurs at the at least one client computer, the at least one client computer reporting a test result of the system test to a server in real time; the server generating a notification instruction to notify a system administration group; a system administrator in the system administration group acquiring a permission and remotely logging in to the server; and the system administrator logging out of the server and releasing the permission.

### CROSS REFERENCE TO RELATED APPLICATION

This non-provisional application claims priority of China patent application No. 201910844055.3, filed on 6 Sep. 2019, included herein by reference in its entirety.

### BACKGROUND OF THE INVENTION

### 1. Field of the Invention

The invention relates to a testing method and a testing system utilizing the same, and specifically, to a method of simultaneously performing tests on a plurality of client computers and reporting test results, and a testing system utilizing the same.

### 2. Description of the Prior Art

During the development and manufacturing processes, computers undergo various reliability tests, including software reliability tests. The software reliability tests comprise basic input output system (BIOS) initialization tests, BIOS hardware tests, memory stress tests, hard drive or solid-state drive stress tests, software compatibility checks, power state tests (e.g., power-on or power-off tests, sleep mode checks, hibernation checks) and central processing unit (CPU) stress tests. All computers are required to pass the above tests to ensure quality thereof. If manual checks are adopted to perform the above tests, it would take a long time to complete the complicated testing procedures, increasing manufacturing costs.

When a computer is adopted in the software reliability test, and a severe system error such as a blue screen of death problem occurs, the computer must stop all the tests and store the test result, waiting for operating personnel to perform a single-computer check on the problematic computer to resolve the problem. As tens, hundreds or even thousands of computers are undergoing tests, the testing time would grow considerably, leading to an exponential growth of workloads and complications for operating personnel.

### SUMMARY OF THE INVENTION

According to one embodiment of the invention, a testing method includes: at least one client computer executing a system test; when a system error occurs at the at least one client computer, the at least one client computer reporting a test result of the system test to a server in real time; the server generating a notification instruction to notify a system administration group of the test result; a system administrator in the system administration group acquiring a permission to remotely log in to the server; and the system administrator logging out of the server and releasing the permission.

According to another embodiment of the invention, a testing system includes at least one client computer and a server. The at least one client computer is used to execute a system test, and when a system error occurs at the at least one client computer, report a test result of the system test in real time. The server is used to receive the test result reported by the at least one client computer and generate a notification instruction to notify a system administration group of the test result. The server provides a permission to manage a quantity of system administrators permissible by the server and a quantity of files accessible by the system administrators.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a testing system according to an embodiment of the invention.

FIG. 2 is a flowchart of a testing method according to an embodiment of the invention.

FIG. 3 is a flowchart of a server testing method according to an embodiment of the invention.

FIG. 4 is a flowchart of a testing method of testing client computers according to an embodiment of the invention.

FIG. 5 is a flowchart of a method of generating an Internet protocol address at a client computer according to an embodiment of the invention.

FIG. 6 is a schematic diagram of a method of generating an Internet protocol address according to another embodiment of the invention.

### DETAILED DESCRIPTION

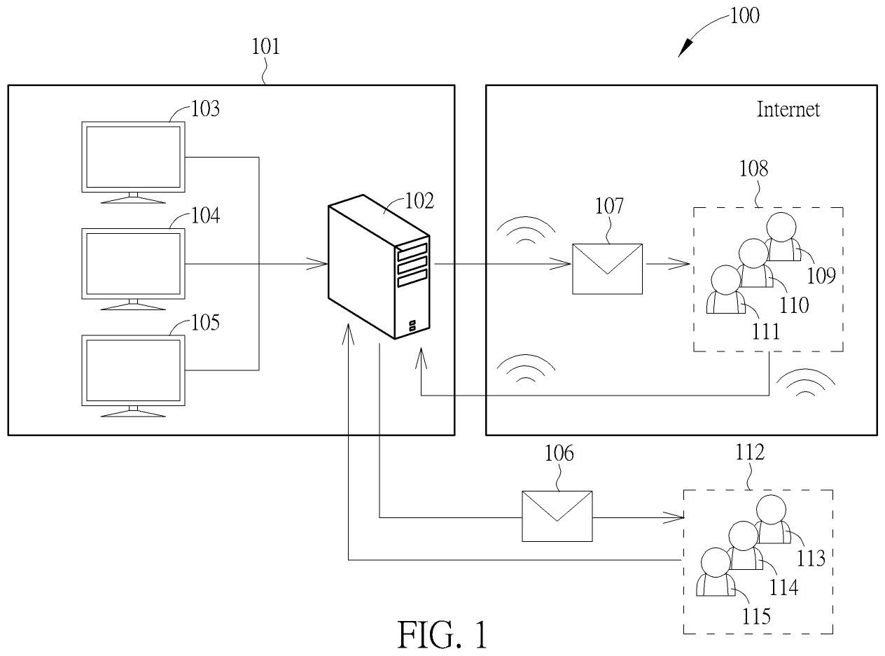

FIG. 1 is a schematic diagram of a testing system 100 capable of executing a reliability test according to an embodiment of the invention. The testing system 100 may monitor test progresses of the client computers 103, 104, 105, report system errors of the client computers 103, 104, 105 in real time, or configure test conditions of the client computers 103, 104, 105. The client computers 103, 104, 105 may execute system tests, and may be connected to a server 102 via a local area network 101. The server 102 may periodically monitor for real-time reports of the client computers 103, 104, 105 to acquire the test progresses thereof. When a system error occurs at at least one of the client computers 103, 104, 105, at least one of the client computers 103, 104, 105 may report a test result of the system test in real time to the server 102. The server 102 may receive the test result reported by at least one client computers 103, 104, 105, generate a notification instruction 107 to notify a system administration group 108 of the test result, and/or generate a notification instruction 106 to notify a system administration group 112 of the test result. The system administration group 108 comprises a plurality of system administrators 109 to 111. The system administration group 112 comprises a plurality of system administrators 113 to 115. The server 102 may employ Email, a social media application such as Line, Messenger, or a team collaboration platform such as Slack to transmit the notification instruction 107 to notify the system administration group 108 of the test result, and all the system administrators 109 to 111 in the system administration group 108 may receive the notification instruction 107. When the server 102 transmits the notification instruction 106 to notify the system administration group 112 of the test result, all the system administrators 113 to 115 in the system administration group 112 may receive the notification instruction 106. The server 102 may provide a permission to manage a quantity of system administrators permissible by the server 102 and a quantity of files accessible by the system administrators.

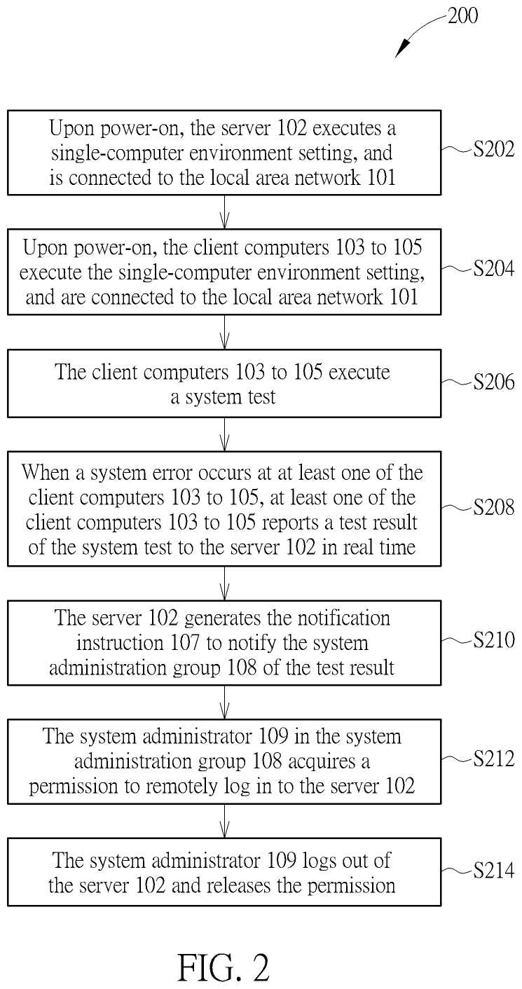

FIG. 2 is a flowchart of a testing method 200 according to an embodiment of the invention. The method 200 in FIG. 2 comprises the following Steps:

Step S202: Upon power-on, the server 102 executes a single-computer environment setting, and is connected to the local area network 101;

Step S204: Upon power-on, the client computers 103 to 105 execute the single-computer environment setting, and are connected to the local area network 101;

Step S206: The client computers 103 to 105 execute a system test;

Step S208: When a system error occurs at at least one of the client computers 103 to 105, at least one of the client computers 103 to 105 reports a test result of the system test to the server 102 in real time;

Step S210: The server 102 generates the notification instruction 107 to notify the system administration group 108 of the test result;

Step S212: The system administrator 109 in the system administration group 108 acquires a permission to remotely log in to the server 102; and

Step S214: The system administrator 109 logs out of the server 102 and releases the permission.

Step S202 is an initialization procedure of the serve 102. Upon power-on, the server 102 executes the single-computer environment setting and is connected to the local area network 101. The single-computer environment setting may comprise a firewall setting, a memory reading and writing test, a hard disk reading and writing test, a network speed test, and other tests. Step S204 is an initialization procedure of the client computers 103 to 105. Step S204 is used to ensure that the client computers 103 to 105 function properly and are connected to the local area network 101. The client computers 103 to 105 may be separately tested to determine whether they can be connected to the server 102.

In Step S206, the client computers 103 to 105 may separately execute different versions of system tests, or all execute a common version of a system test. For example, a client A may simultaneously execute a common version 2.1 of the system test and stress test on the client computers 103 to 105, or separately execute a version 2.1.0, a version 2.1.1, and a version 2.1.2 of the system tests respectively on the client computers 103 to 105 to achieve tests for different versions of reliability tests. In Step S208, when the system error occurs at at least one of the client computers 103 to 105, at least one of the client computers 103 to 105 reports, in real time, the test result of the system test to the server 102. In one embodiment, the system errors may be defined as various severity levels. If the subsequent system test is unaffected by the system error, the system error is defined as the lowest severity level, e.g., a file is not found, and after the client computer having the system error reports the test result in real time to the server 102, the client computer may continue executing the subsequent system test. If the error has a high severity level, e.g., blue screen of death, the client computer having the system error may stop the system test, and report the test result in real time to the server 102. In another embodiment, the client computer having the high severity level of the system error may be reset. If the client computer passes the single-computer environment setting test after reset, then the client computer may execute the remaining system tests until a quantity of the tests has reached a quantity of verified tests.

In Step S210, when the server 102 receives a test result from any of the client computers 103 to 105, the server 102 generates the notification instruction 107 to notify the system administration group 108 of the test result. The server 102 may employ Email, a social media application such as Line, Messenger, or a team collaboration platform such as Slack to transmit the notification instruction 107 to notify the system administration group 108 of the test result. The system administration group 108 may comprise the plurality of system administrators 109 to 111. In one embodiment, system administrators may be configured for different projects in the server 102. For example, the system administration group 108 responsible for a BIOS project may comprise the system administrators 109, 110, 111, and the system administration group 112 responsible for a linux project may comprise the system administrators 113, 114, 115. A system administrator may belong to several system administration groups based on project requirements.

In Step S210, since the notification instruction has been received, the system administrator 109 in the system administration group 108 attempts to remotely log in to the server 102. When the system administrator 109 acquires the permission provided by the server 102, the system administrator 109 uses the permission to remotely log in to the server 102, and as a result, the system administrator 109 can view the test result reported from the client computers 103 to 105. The server 102 provides the permission to manage the quantity of system administrators permissible by the server 120 and the quantity of files accessible by the system administrators. In one embodiment, the permission further comprises names and passwords of the system administrators, and files accessible by the system administrators. The server 120 employs the names and the passwords of the system administrators to verify the identity of the system administrators. For example, the system administrator 111 is required to enter the correct name and password before logging into the server 102. After the system administrator 111 logs into the server 102, the system administrator 111 can only view files having readable, writable, or deletable permissions on the screen.

In one embodiment, to avoid one file being used by several system administrators, the permission issued by the server 102 only allows one system administrator to log in at a time. In another embodiment, the permission issued by the server 102 includes a file access status. If a file A has been accessed by the system administrator 111, then after the system administrator 110 logs in to the server 102 and requests an access to the same file A, the server 102 will issue a notification to the system administrator 110 to reject the request for the access to the same file A.

In Step S214, after the system administrator 109 logs out of the server 102, the permission will be released, and the server 102 will grant an access to another system administrator.

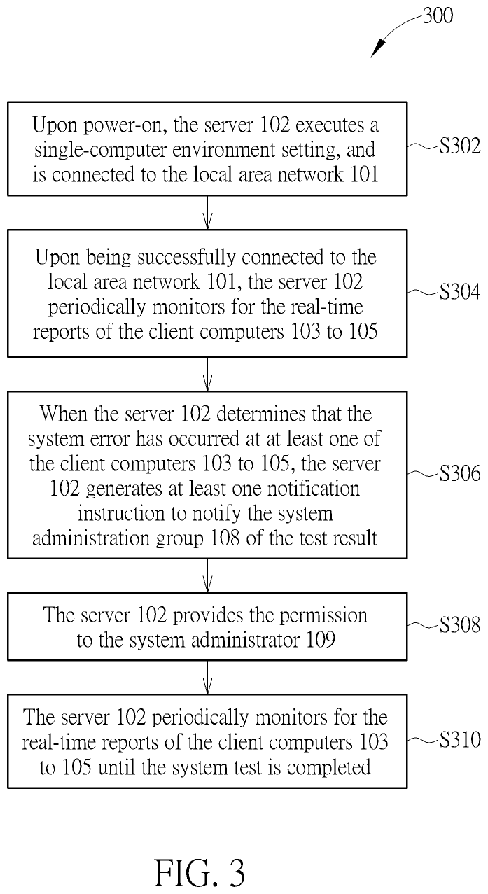

FIG. 3 is a flowchart of a server testing method 300 according to an embodiment of the invention. The method 300 in FIG. 3 comprises the following Steps:

Step S302: Upon power-on, the server 102 executes a single-computer environment setting, and is connected to the local area network 101;

Step S304: Upon being successfully connected to the local area network 101, the server 102 periodically monitors for the real-time reports of the client computers 103 to 105;

Step S306: When the server 102 determines that the system error has occurred at at least one of the client computers 103 to 105, the server 102 generates at least one notification instruction to notify the system administration group 108 of the test result;

Step S308: The server 102 provides the permission to the system administrator 109; and

Step S310: The server 102 periodically monitors for the real-time reports of the client computers 103 to 105 until the system test is completed.

In Step S302, after power-on, the server 102 executes the single-computer environment setting and is connected to the local area network 101. The single-computer environment setting may comprise a firewall setting, a memory reading and writing test, a hard disk reading and writing test, a network speed test, and other tests. In Steps S304 and S306, upon being successfully connected to the local area network 101, the server 102 starts periodically monitoring for the real-time reports of the client computers 103 to 105, and processes the real-time reports of the client computers 103 to 105. The server 102 contains a determination procedure, determining the system errors and severity levels of the system errors reported in real-time by the client computers 103 to 105, so as to generate the notification instruction 107 to notify the system administration group 108 of the test result. For example, when the system errors occur at both the client computers 103 and 104, the server 102 will issue two notification instructions describing the system error of the client computer 103 and the system error of the client computer 104, respectively, so as to notify the system administration group 108 of the test result. The server 102 may employ Email, the social media application such as Line, Messenger, or the team collaboration platform such as Slack to transmit the notification instructions to notify the system administration group 108 of the test result.

In one embodiment, the server 102 may define various system administration groups. For example, the system administration group 108 is defined to process BIOS-relating problems, and the system administration group 112 is defined to process Windows-relating problems. The client computer 103 may execute a BIOS test, and the client computer 104 may execute a Windows test. When a system error occurs at the client computer 103, the server 102 generates the notification instruction 107 to notify the system administration group 108 of the test result, and when a system error occurs at the client computer 104, the server 102 generates the notification instruction 106 to notify the system administration group 112 of the test result. The system administration group 108 will not receive a notification instruction notifying of a system error relating to the Windows test and not responsible by the system administration group 108. The server 102 may employ Email, a social media application such as Line, Messenger, or a team collaboration platform such as Slack to transmit the notification instructions to notify the system administration groups 108, 112 of the test results.

After the system administration group 108 receives the notification instruction 107, the system administrator 109 in the system administration group 108 attempts to remotely log in to the server 102. In Step S308, the server 102 provides the permission to the system administrator 109. The server 102 employs the permission to manage the quantity of system administrators for simultaneous logins permissible by the server 102 and the quantity of files accessible by the system administrators. The system administrator 109 may access a file in the server 102 using a file transfer protocol, a remote access control, or a virtual personal network. The system administrator 109 may determine, via the server 102, the client computer having the system error and acquire the test result of the client computer having the system error.

Next, the server 102 periodically monitors for the real-time reports of the client computers 103 to 105 until the system test is completed.

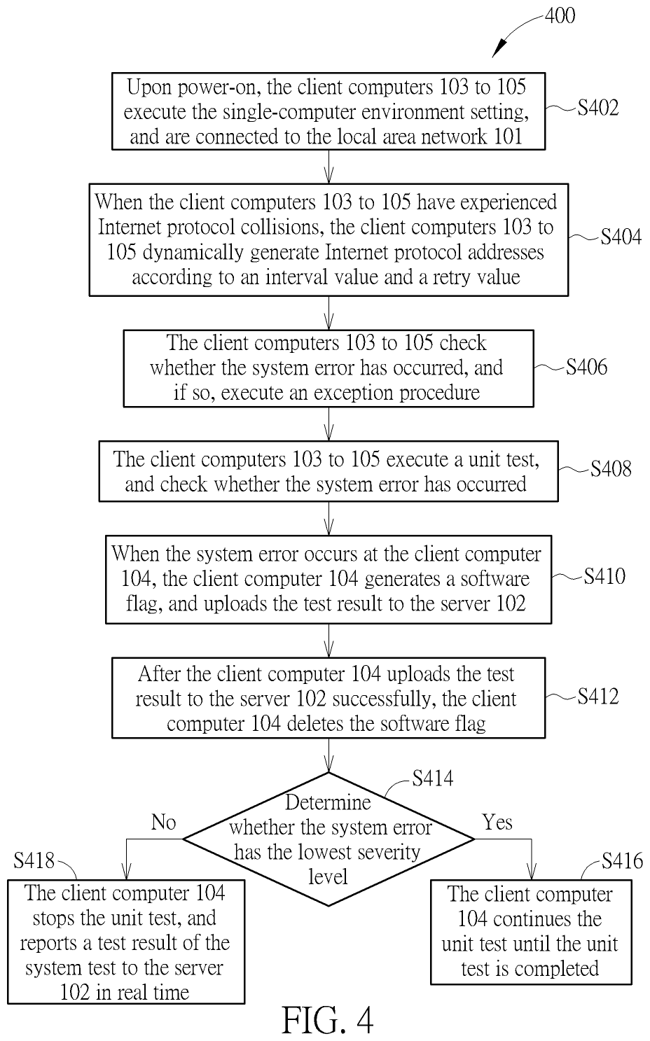

FIG. 4 is a flowchart of a testing method 400 of testing a client computer according to an embodiment of the invention. The method 400 in FIG. 4 comprises the following Steps:

Step S402: Upon power-on, the client computers 103 to 105 execute the single-computer environment setting, and are connected to the local area network 101;

Step S404: When the client computers 103 to 105 have experienced Internet protocol collisions, the client computers 103 to 105 dynamically generate Internet protocol addresses according to an interval value and a retry value.

Step S406: The client computers 103 to 105 check whether the system error has occurred, and if so, execute an exception procedure;

Step S408: The client computers 103 to 105 execute a unit test, and check whether the system error has occurred;

Step S410: When the system error occurs at the client computer 104, the client computer 104 generates a software flag, and uploads the test result to the server 102;

Step S412: After the client computer 104 uploads the test result to the server 102 successfully, the client computer 104 deletes the software flag;

Step S414: Determine whether the system error has the lowest severity level; if so, go to Step S416; and if not, go to Step S418;

Step S416: The client computer 104 continues the unit test until the unit test is completed.

Step S418: The client computer 104 stops the unit test, and reports a test result of the system test to the server 102 in real time.

In Step S402, each of the client computers 103 to 105 executes the single-computer environment setting upon power-on. The single-computer environment setting may comprise a firewall setting, a network connection test, and others. Next, each of the client computers 103 to 105 is connected to the local area network 101. In Step S406, if a system error occurs when the client computers 103 to 105 execute the single-computer environment setting, at least one of the client computers 103 to 105 is required to execute an exception procedure to eliminate the system error. For example, a network connection failure and a memory test failure occur when the client computer 104 executes the single-computer environment setting, and as a consequence, the system administrator 109 will check the client computer 104 in person and eliminate the problem, e.g., if the problem is associated with an unfavorable wiring contact, a wiring having a favorable contact may be used to replace the wiring having the unfavorable contact.

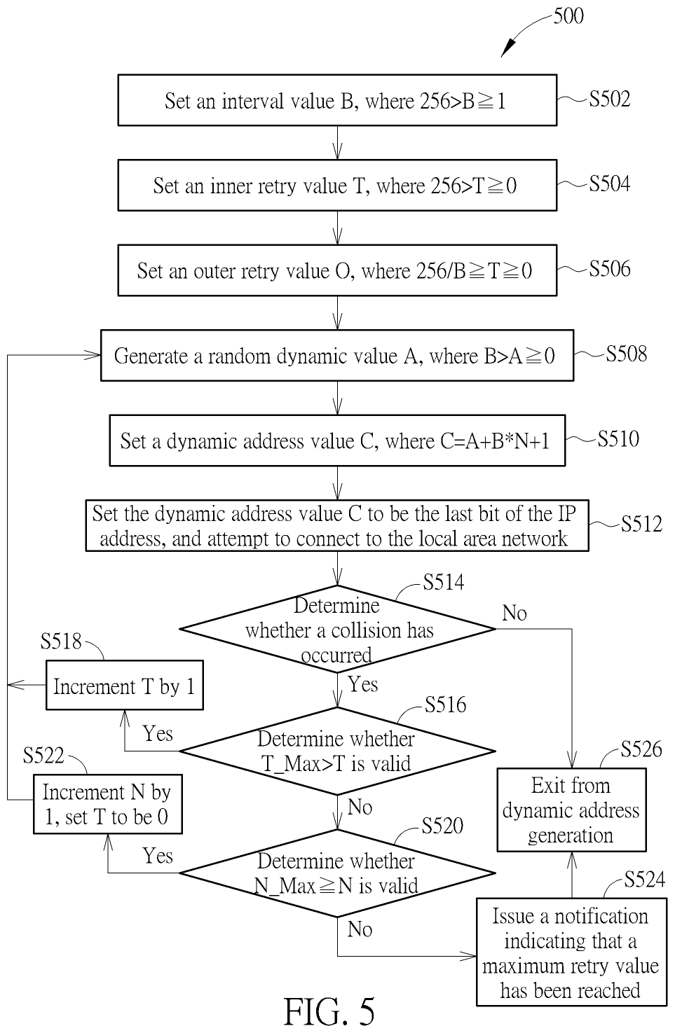

Since the system test takes place in the local area network 101 containing the plurality of client computers 103 to 105, an Internet protocol (IP) collision may occur. An IP collision occurs when two or more client computers 103, 104 using the same IP address. When an IP collision occurs, the client computer will dynamically generate a new Internet protocol address, and upload the test result to the server. In Step S404, when the client computers 103 to 105 has experienced Internet protocol collisions, the client computers 103 to 105 dynamically generate Internet protocol addresses according to an interval value and a retry value and using the method 500 in FIG. 5.

In Step S408, the client computers 103 to 105 start executing the system test comprising a plurality of unit tests. For example, the system test may be a BIOS test, a single-computer stability test, a single-computer reading and writing test, a server connection and load test, or others. The BIOS test comprises a plurality of unit tests such as a CPU initialization test, a RAM test, a hardware interrupt procedure test, and others. During the process of execution, the client computers 103 to 105 check in real time whether a system error has occurred. In Step S410, when the system error occurs at the client computer 104, the client computer 104 having the system error generates a software flag, and uploads the test result to the server 102. Since the system error has occurred, the client computer 104 employs the software flag to ensure that the test result may be successfully uploaded to the server 102, and synchronizes a testing status of the client computer 104 on the server 102 for use in a status check. If the test result has been successfully uploaded to the server 102, in Step S412, the client computer 104 deletes the software flag; and if the test result has failed to be uploaded to the server 102, the client computer 104 keeps the software flag, and stores the test result in a non-volatile memory or hard drive of the client computer 104 to prevent the test result from being lost.

In one embodiment, the system errors may be defined as various severity levels. If it is determined that the system error is at the lowest severity level, after the client computer 104 having the system error reports the test result in real time to the server 102, the client computer 104 continues executing the subsequent system test. In Step S416, the client computer 104 continues the unfinished unit tests until the unit tests are completed. If it is determined that the system error is at the high severity level, Step S418 is executed, the client computer 104 terminates the unit test, and reports a test result of the system test to the server 102 in real time. In another embodiment, the client computer 104 having the high severity level of the system error may be reset. If the client computer 104 passes the single-computer environment setting test after reset, then the client computer 104 may execute the remaining system tests until a quantity of the tests has reached a quantity of verified tests.

FIG. 5 is a flowchart of a method 500 of generating an Internet protocol address at a client computer according to an embodiment of the invention.

The method 500 in FIG. 5 comprises the following Steps:

Step S502: Set an interval value B, where 256>B≥1;

Step S504: Set an inner retry value T, where 256>T≥0;

Step S506: Set an outer retry value O, where 256/B≥T≥0;

Step S508: Generate a random dynamic value A, where B>A≥0;

Step S510: Set a dynamic address value C, where C=A+B*N+1;

Step S512: Set the dynamic address value C to be the last bit of the IP address, and attempt to connect to the local area network;

Step S514: Determine whether a collision has occurred; if so, go to Step S516; and if not, go to Step S526;

Step S516: Determine whether T_Max≥T is valid; if so, go to Step S518; and if not, go to Step S520;

Step S518: Increment T by 1; go to Step S508;

Step S520: Determine whether N_Max≥N is valid; if so, go to Step S522; and if not, go to Step S524;

Step S522: Increment N by 1, set T to be 0; go to Step S508;

Step S524: Issue a notification indicating that a maximum retry value has been reached; go to Step S526;

Step S526: Exit from dynamic address generation.

IPv4 and IPv6 standards may be adopted in local area networks to generate Internet protocol addresses. In one embodiment, when the local area network adopts the IPv4 standard, a network address has a maximum value of 255. In another embodiment, when the local area network adopts the IPv6 standard, a network address has a maximum value of 0xFFFF, or 65535. In the method 500, the dynamic address generated is used to update only the value in the last number of an IP address. For example, if the IPv4 address is X1.X2.X3.X4, the dynamic address generated is used to update X4 in the IP address.

In Step S502, the system administrator sets an interval value B, and a dynamic value A is randomly generated, with B>A≥0 being satisfied. For example, the local area network 101 adopts the IPv4 standard, the IPs in the local area network 101 may range from 192.168.0.0 to 192.168.0.255, indicating that up to 256 IPs may be simultaneously employed in the local area network 101.

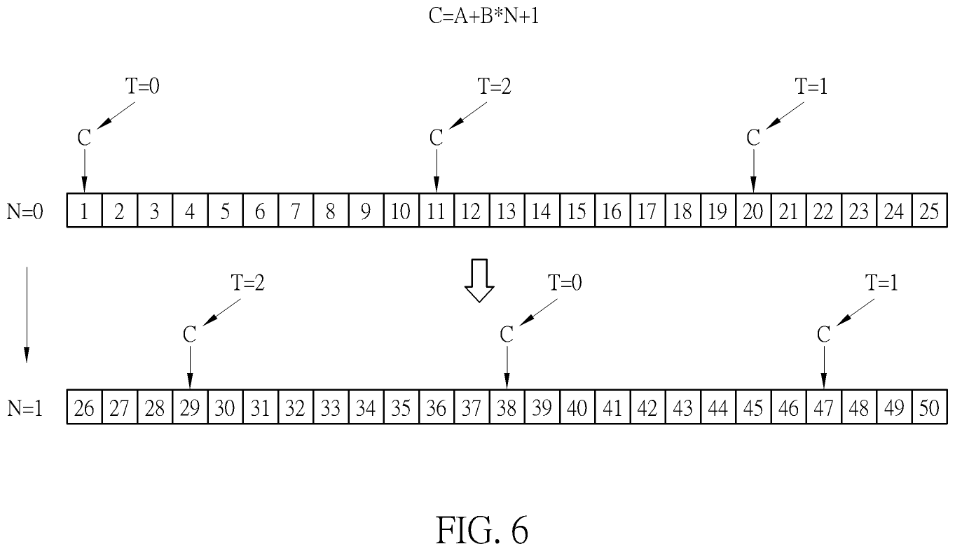

In Step S502, when the system administrator sets the interval value B to be 25, as indicated in FIG. 6, for N=0, the dynamic address ranges from 1 to 25, and for N=1, the dynamic address ranges from 26 to 50. In Step S504, an inner retry value T is set, starting from 0, having a maximum value T_Max, and being predefined as 3. In the embodiment, the maximum value T_Max is less than the maximum allowable total IP quantity. In Step S506, an outer retry value N is set, starting from 0 and having a maximum value N_Max of 255/25. In the embodiment, N is 10, and the total retry quantity is T*N=3*10=30 in the method 500. In Step S502, a dynamic value A is randomly generated as 1, satisfying 25>A≥0. In Step S510, the dynamic address C is calculated as C=1+25*0+1, or C=2. Thus in Step S512, the client computer employs the IP address 192.168.0.2 to attempt to connect to the local area network. In Step S514, if the client computer experiences no IP collision, i.e., no other computer uses the IP address 192.168.0.2, the method 500 continues at Step S526 to exit from IP address generation, whereas if the client computer experiences an IP collision, the method 500 continues at Step S516.

In Step S516, when T<T_Max, the maximum retry value in the internal has not yet been reached, the value T is incremented by 1. In the embodiment, the value T becomes 1, and the method 500 returns to Step S508 to again randomly generate a new dynamic value A and continues to generate another address in the interval. In Step S516, when T=T_Max, the maximum retry value is reached, the method 500 goes to Step S520.

In Step S520, when N_Max the maximum retry value has not yet been reached, the method 500 goes to Step S522 to increment N by 1. In the embodiment, N is set to 1, T is set to 0, the method 500 returns to Step S508 to continue generating a new dynamic address. In Step S520, when N>N_Max, the maximum retry value has been reached, the method 500 goes to Step S524, a notification of the maximum retry attempts having been reached is issued to notify the system administrator that no new IP address may be generated, then the method 500 goes to Step S526 to exit from dynamic address generation.

FIG. 6 is a schematic diagram of the method 500 of generating an Internet protocol address according to another embodiment of the invention. The interval value B is set to be 25, T_Max is preset to be 3, and C=A+B*N+1. N is initialized as 0.

As shown in FIG. 6, T=0 for the first attempt, A is dynamically generated as 0, C=0+0*25+1=1, thus the generated dynamic address C is 1. T=1 for the second attempt, A is dynamically generated as 19, C=19+0*25+1=20, thus the generated dynamic address C is 20. T=2 for the third attempt, A is dynamically generated as 10, C=10+0*25+1=11, thus the generated dynamic address C is 11. T=3 for the fourth attempt, in Step S516, it is determined that T<T_Max is invalid, thus the method 500 goes to Step S520. In Step S520, N=0, N_Max≥N is valid, thus the method 500 goes to Step S522. In Step S522, N is incremented by 1, N=1, and T is set to be 0, thus the method 500 goes to Step S508.

In Step S508, as shown in FIG. 6, a dynamic address is generated for N=1. T=0 for the first attempt, A is dynamically generated as 12, C=12+1*25+1=38, thus the generated dynamic address C is 38. T=1 for the second attempt, A is dynamically generated as 21, C=21+1*25+1=47, thus the generated dynamic address C is 47. T=2 for the third attempt, A is dynamically generated as 3, C=3+1*25+1=29, thus the generated dynamic address C is 29. The method 500 continues accordingly, until the dynamic address generation is terminated.

The embodiments provide a testing method, including at least one client computer executing a system test. The at least one client computer may separately execute different versions of system tests, or all execute a common version of a system test. When a system error occurs at the client computer, the client computer actively reports a test result of the system test to the server in real time, and then the server generates a notification instruction to notify a system administration group of the test result. The server may contain a plurality of system administration groups, and each system administration group may contain a plurality of system administrators. The server may define different system administration groups such as a BIOS group and an operating system group to achieve efficient real-time processing. The server may employ Email, a social media application such as Line, Messenger, or a team collaboration platform such as Slack to transmit the notification instruction to notify the system administration groups. Since the system error may be classified into various severity levels, e.g., the high severity level will result in client computer halting. In the embodiment, the real-time notification allows a system administrator in the system administration group to acquire a permission and remotely log in to the server to resolve the system error of the client computer. In order to prevent the same file from being accessed by several system administrators at the same time, the server 102 may define the permission to manage the quantity of system administrators permissible by the server and the quantity of files accessible by the system administrators. The permission will be released when the system administrator logs out of the server, to enable others to use the permission.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A testing method comprising:
at least one client computer executing a system test;
when a system error occurs at the at least one client computer, the at least one client computer reporting a test result of the system test to a server in real time;
the server generating a notification instruction to notify a system administration group of the test result;
a system administrator in the system administration group acquiring a permission to remotely log in to the server; and
the system administrator logging out of the server and releasing the permission.

2. The testing method of claim 1, wherein the notification instruction is transmitted using an email or a social media application.

3. The testing method of claim 1, wherein the permission is used to manage a quantity of system administrators permissible by the server and a quantity of files accessible by the system administrators.

4. The testing method of claim 1, further comprising:
upon power-on, the server executing a single-computer environment setting, and connecting to a local area network;
upon being successfully connected to the local area network, the server periodically monitoring for real-time reports of the client computers;
when the server determines that the system error has occurred at the at least one client computer, the server generating the notification instruction to notify the system administration group of the test result;
the server providing the permission to the system administrator; and
the server periodically monitoring for real-time reports of the client computers until the system test is completed.

5. The testing method of claim 4, wherein the permission comprises:
providing, using a file transfer protocol service, a remote access control service, or a virtual personal network, a file from the server accessed by the system administrator.

6. The testing method of claim 1, further comprising:
upon power-on, the client computer executing a single-computer environment setting, and connecting to a local area network;
the client computer checking whether the system error has occurred, and if so, executing an exception procedure;
the client computer executing a unit test, and checking whether the system error has occurred;
when the system error occurs at the at least one client computer, the at least one client computer generating a software flag, and uploading the test result to the server;
when the client computer uploading the test result to the server successfully, the client computer deleting the software flag; and
the at least one client computer executing the unit test until the system test is completed.

7. The testing method of claim 6, further comprising when an Internet protocol collision has occurred in the local area network, the at least one client computer dynamically generating an Internet protocol address according to an interval value and a retry value.

8. The testing method of claim 6, wherein the exception procedure comprises resetting software, resetting hardware, or resetting after power-down.

9. A testing system comprising:
at least one client computer configured to execute a system test, and when a system error occurs at the at least one client computer, report a test result of the system test in real time; and
a server, configured to receive the test result reported by the at least one client computer and generate a notification instruction to notify a system administration group;
wherein the server provides a permission to manage a quantity of system administrators permissible by the server and a quantity of files accessible by the system administrators.

10. The testing system of claim 9, wherein the notification instruction is transmitted using an email or a social media application.
